(19) United States
(12) Patent Application Publication
(10) Pub. No.: US 2007/0261905 A1
(43) Pub. Date: Nov. 15, 2007

(54) ELECTRICALLY OPERATED THREE-WHEELED PUSHCART

(75) Inventor: Paul LIN, Yung-Kang City (TW)

Correspondence Address: AKIN GUMP STRAUSS HAUER & FELD L.L.P., ONE COMMERCE SQUARE, 2005 MARKET STREET, SUITE 2200, PHILADELPHIA, PA, 19103, US

(73) Assignee: Macauto Industrial Co., Ltd., Yung-Kang City (TW)

(21) Appl. No.: 11/383,068

(22) Filed: May 12, 2006

(51) Int. Cl. B60K 1/00

(52) U.S. Cl. 180/213; 180/65.5

(57) ABSTRACT

A pushcart for carrying and transporting loads includes a main support frame supporting a load-carrying part and having a front end provided with a pair of front wheels and a rear end to which a wheel frame is attached pivotably, a rear wheel rotatably attached to the wheel frame, a power unit disposed on the main support frame for driving the rear wheel, and a handle attached pivotally to the rear end and connected to the wheel frame for steering the rear wheel.

### BACKGROUND OF THE INVENTION

1. Field of the Invention

The present invention relates to a pushcart, more particularly to an electrically operated three-wheeled pushcart for carrying and transporting loads.

2. Description of the Related Art

Pushcarts such as wheelbarrows are usually used in factories, construction sites or farms as a convenient means for carrying and transporting items, particularly heavy loads. There are currently numerous and various types of pushcarts appearing in the market, and they may be generally categorized as being manually driven or electrically driven according to the operational configuration thereof. Referring to electrically operated pushcarts, the conventional electrically operated pushcart comprises a main support frame having a handle, a load-carrying part disposed on top of the main support frame, a pair of front wheels disposed under the front end of the main support frame, a rear wheel disposed under the rear end of the main support frame, and a power unit mounted underneath the main support frame and electrically connected to the handle and front wheels.

To drive the pushcart to advance forward, an operator operates a control in the handle to turn on the power unit to drive the front wheels to rotate, which in turn drive the rear wheel to advance. However, since the front wheels are mounted on the left and right sides of the pushcart, the power unit must simultaneously drive the two front wheels to rotate. Thus, an externally connected motor connected to a storage battery, which is employed as the power source, must be used in conjunction with a differential mechanism provided between the two front wheels so as to be able to synchronize the two front wheels. As a result, the construction of the power unit in conjunction with the front wheels is manifestly complicated and difficult. Therefore, there is a need for an improvement in design. The present invention is thus contrived in an attempt to alleviate the above shortcomings of the prior art.

### SUMMARY OF THE INVENTION

Therefore, a main object of the present invention is to provide an electrically operated pushcart of simple construction.

Accordingly, a pushcart for carrying and transporting loads according to the present invention comprises a main support frame supporting a load-carrying part, and having a front end provided with a pair of front wheels and a rear end, and a wheel frame attached pivotally to the rear end, a rear wheel rotatably attached to the wheel frame, a power unit for driving the rear wheel, and a handle attached pivotally to the rear end and connected to the wheel frame for steering the rear wheel.

### BRIEF DESCRIPTION OF THE DRAWINGS

Other features and advantages of the present invention will become apparent in the following detailed description of the preferred embodiments with reference to the accompanying drawings, in which:

FIG. 1 is a side view of a first preferred embodiment of the pushcart according to the present invention;

FIG. 2 is a top view of the first preferred embodiment with the load-carrying part of the pushcart being removed;

FIG. 3 is a side view of a second preferred embodiment of the pushcart according to the present invention; and

FIG. 4 shows a motor provided in the rear wheel of the pushcart.

### DETAILED DESCRIPTION OF THE PREFERRED EMBODIMENTS

In the following detailed description of the preferred embodiments, it should be noted that similar elements are denoted by the same reference numerals.

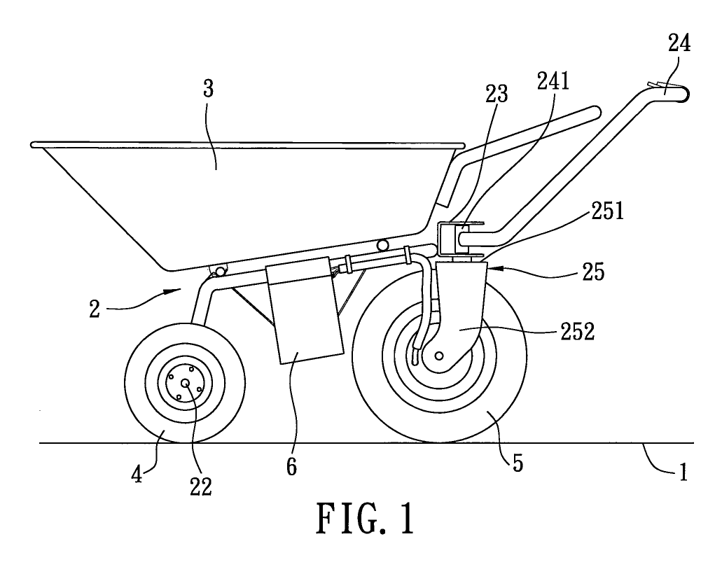

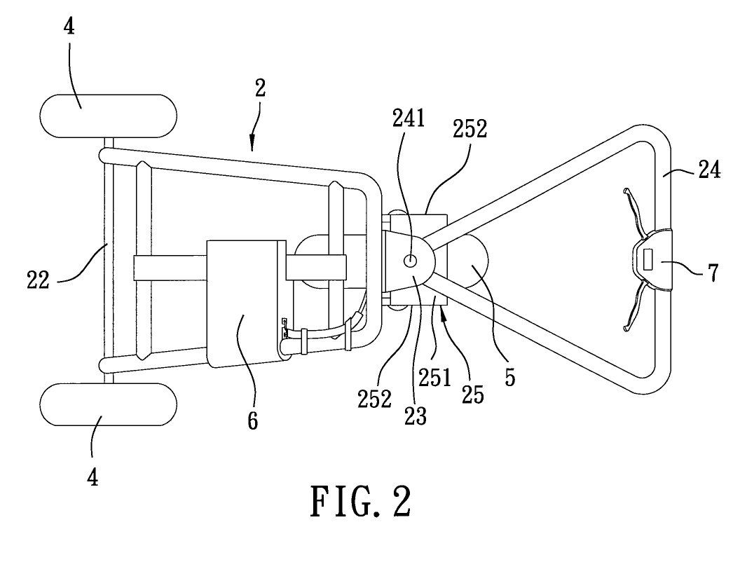

As shown in FIGS. 1 and 2, an electrically operated pushcart for carrying and transporting loads according to a first preferred embodiment of the present invention generally comprises a main support frame 2 supporting a load-carrying part 3, a pair of front wheels 4, a rear wheel 5, a handle 24 for steering the rear wheel 5, and a power unit 6.

The main support frame 2 has a front end to which an axle 22 is attached and a rear end to which a wheel frame 25 is pivotally attached. The front wheels 4 are rotatably mounted on the two opposing ends of the axle 22, respectively, while the handle 24 is attached to the wheel frame 25. In this embodiment, the rear end of the main support frame 2 has an engagement seat 23 attaching pivotally the handle 24 and the wheel frame 25 to the rear end of the main support frame 2. An end of the handle 24 is received in the engagement seat 23, while the wheel frame 25 is positioned under the engagement seat 23. The end of the handle 24 and the wheel frame 25 are attached to a pivot shaft 241 that is attached rotatably to engagement seat 23. By such construction, the handle 24, wheel frame 25 and pivot shaft 241 are rotatable about a vertical axis of the pivot shaft 241 relative to the engagement seat 23. Consequently, the rear wheel 5 can be steered to a desired direction simply by swinging the handle 24 to the left or right.

The wheel frame 25 is of a substantially U-shape plate structure and includes a substantially horizontal connecting plate 251 and a pair of side plates 252 extending downward from the connecting plate 251. The rear wheel 5 is rotatably mounted between the side plates 252 via a spindle 51 inserted through the side plates 252 and rear wheel 5. The side plates 252, in this embodiment, are formed to have a bottom end that is curved forwardly. The connecting plate 251 of the wheel frame 25 is attached to the pivot shaft 241 and is rotatable about the vertical axis of the pivot shaft 241 relative to the main support frame 2.

The load-carrying part 3 supported on top of the main support frame 2 is for carrying a load (not shown in the drawings).

The rear wheel 5 is an electrically driven wheel having an outer diameter larger than that of the front wheels 4. These three wheels support the main support frame 2 onto the ground 1.

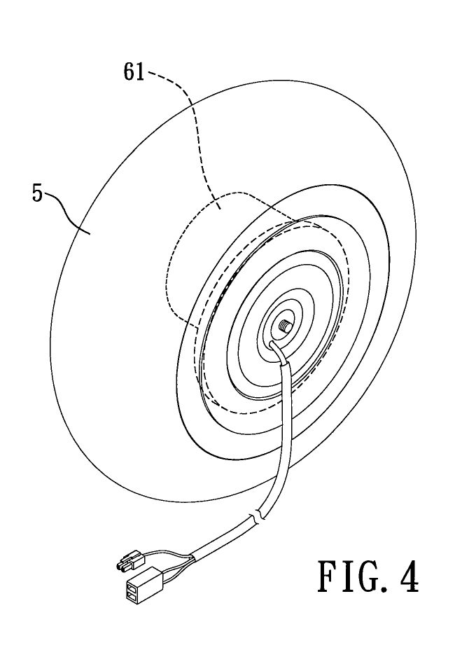

The power unit 6 includes a common storage battery mounted beneath the main support frame 2, and a motor 61 (shown in phantom lines in FIG. 4) electrically connected to the battery of the power unit 6 and disposed inside the rear wheel 5, for driving the rear wheel 5. Since the motor 61 may be mounted inside the rear wheel 5 in any known manner, this aspect is not further detailed herein. In an alternate design, a control unit 7 (see FIG. 2) that controls the power unit 6 may be provided on the handle 24 to facilitate control and driving of the pushcart. Such design is conventional and is thus not discussed further herein.

The overall electrically operated pushcart is supported on the ground 1 by the rear wheel 5 and front wheels 4. To move and advance the pushcart, the operator may grip the handle 24 to control and steer the pushcart to the desired direction, and turn on the power unit 6 to drive the rear wheel 5 into rotation, which in turn urges the front wheels 4 for synchronous rotation and advancement.

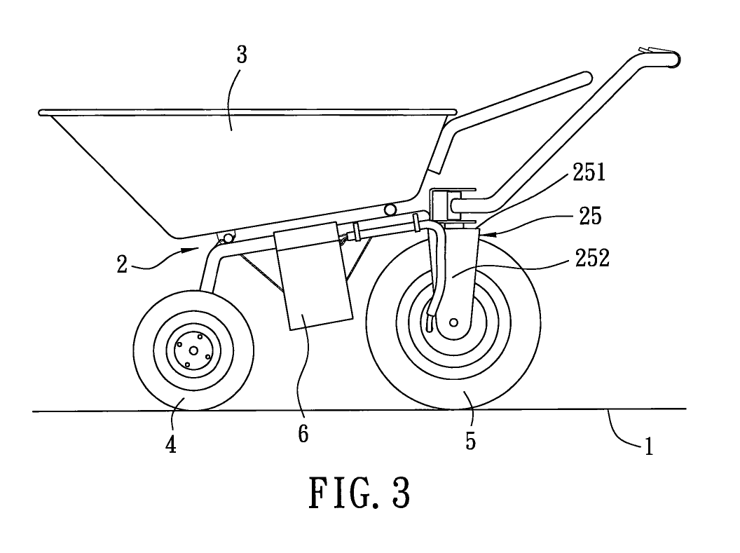

A second preferred embodiment of the pushcart of the present invention is shown in FIG. 3. The second preferred embodiment is of substantially the same structure as the first preferred embodiment, differing only in the shape of the wheel frame 25. In the second preferred embodiment, the two side plates 252 of the wheel frame 25 extend downwardly vertically from the two sides of the connecting plate 251, respectively, without any curved configuration formed at the bottom end. Such structure can similarly achieve the effect of allowing stable rotation of the rear wheel 5.

It can be appreciated, from the above description, that the electrically operated pushcart of the present invention, which is designed such that only one wheel, namely the rear wheel 5 mounted under the main support frame 2, incorporates a drive unit such as the motor 61 to advance the pushcart, eliminates the necessity for additionally installing a differential mechanism. Therefore, the structural design of the present invention for the drive operation is not only simple, but the commercially available driven wheel can be employed in the present invention, thus simplifying the overall design.

It will be understood that the present invention may be embodied in other specific forms without departing from the spirit or central characteristics thereof. The present embodiments, therefore, are to be considered in all respects as illustrative and not restrictive, and the present invention is not to be limited to the details given herein.

What is claimed is:

1. A pushcart for carrying and transporting loads comprising:
a main support frame supporting a load-carrying part, and having a front end provided with a pair of front wheels and a rear end and a wheel frame attached pivotably to said rear end;
a rear wheel rotatably attached to said wheel frame;
a power unit for driving said rear wheel; and
a handle attached pivotally to said rear end and connected to said wheel frame for steering said rear wheel.

2. The pushcart of claim 1, wherein said wheel frame is of a substantially U-shape plate structure that includes a substantially horizontal connecting plate and a pair of side plates extending downward from said connecting plate, said rear wheel being rotatably mounted between said side plates, said connecting plate being rotatable about a vertical axis relative to said main support frame.

3. The pushcart of claim 2, wherein said side plates each have a bottom end that is curved forwardly.

4. The pushcart of claim 1, wherein said power unit includes a battery and a motor, said motor being disposed inside said rear wheel, said battery being disposed beneath said main support frame.

5. The pushcart of claim 1, wherein said rear wheel has an outer diameter greater than that of said front wheels.
